(19) United States
(12) Patent Application Publication
(10) Pub. No.: US 2013/0301869 A1
(43) Pub. Date: Nov. 14, 2013

(54) FORENSIC MARKING APPARATUS AND METHOD FOR REAL-TIME CONTENT SERVICE

(71) Applicant: Electronics and Telecommunications Research Institute, (US)

(72) Inventors: Yong-Seok SEO, Daejeon (KR); Wonyoung Yoo, Daejeon (KR); Sang Kwang Lee, Daejeon (KR); Jee Hyun Park, Daejeon (KR); Seungjae Lee, Daejeon (KR); Young-Suk Yoon, Daejeon (KR); JungHyun Kim, Daejeon (KR); Young Ho Suh, Daejeon (KR)

(73) Assignee: ELECTRONICS AND TELECOMMUNICATIONS RESEARCH INSTITUTE, Daejeon (KR)

(21) Appl. No.: 13/848,087

(22) Filed: Mar. 21, 2013

(30) Foreign Application Priority Data
May 9, 2012 (KR) 10-2012-0049300
Jan. 18, 2013 (KR) 10-2013-0006058

(51) Int. Cl. G06T 1/00

(52) U.S. Cl. CPC G06T 1/0021
USPC 382/100

(57) ABSTRACT

A forensic marking apparatus includes a preprocessing unit configured to selectively perform preprocessing for forensic processing on content to be provided to a user terminal; and a forensic processing unit configured to perform forensic marking on the content by combining content files preprocessed by the preprocessing unit or perform the forensic marking on an uncompressed original content file in real time, in accordance with a forensic processing method set for the content. Further, the forensic marking apparatus includes a control unit configured to determine the forensic processing method for the content, to control the forensic processing unit so that forensic processing is performed on the content in accordance with the determined method, and to provide the forensic-processed content to the user terminal.

### CROSS-REFERENCE TO RELATED APPLICATIONS

The present invention claims priority of Korean Patent Application No. 10-2012-0049300, filed on May 09, 2012, and Korean Patent Application No. 10-2013-0006058, filed on Jan. 18, 2013, which are incorporated herein by references.

### FIELD OF THE INVENTION

The present invention relates to a forensic marking apparatus and method for content; and, more particularly, to a forensic marking apparatus and method for a real-time content service, which, in order to perform forensic marking on content in a service of providing content, such as audio or video content, in real time online, determine a forensic processing method based on the frequency of requests for each piece of content, and then perform forensic marking by combining preprocessed content files for the content or by performing forensic marking on an uncompressed original content file in real time, in accordance with the determined forensic processing method, thereby reducing the load of a content server and increasing the efficiency of storage.

### BACKGROUND OF THE INVENTION

In general, forensic marking technology is used to insert vendor, author or purchaser information into multimedia content, and is intended to, in the case of illegal distribution of the content, enable the inserted information to be extracted and then used to identify a distributor.

For example, when an online service provider (OSP) inserts purchaser information into content using forensic marking technology when providing the content, the OSP may check distributed content for the forensic mark and then hold an initial distributor responsible for the illegal distribution of the content when the illegal distribution of the content occurs.

Meanwhile, the process of inserting a forensic mark into multimedia content requires a considerably large amount of computational load and a considerably long time because the process involves the step of decoding content, the step of inserting a forensic mark and the step of encoding the content.

As a result, when a plurality of service requests are simultaneously made to a server that provides a real-time download and streaming service for content, such as digital audio or video content, there arises a problem in that forensic marking for each piece of content, which requires a large amount of computation load and a considerably long time, imposes a considerable load on the server.

### SUMMARY OF THE INVENTION

Hereinafter, embodiments of the present invention will be described in detail which form a part hereof.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

In view of the above, the present invention provides a method of inserting a forensic mark, that is, user identification information, in a server in order to provide a real-time download and streaming service related to digital audio content or the like and a system framework for supporting the efficient management of the server.

Further, the present invention provides a method which is capable of reducing the load of a server attributable to simultaneous multiple service requests upon inserting forensic marks in real time.

Furthermore, the present invention provides a forensic marking apparatus and method for a real-time content service, which, in order to perform forensic marking on content in a service of providing content, such as audio or video content, in real time online, determine a forensic processing method based on the frequency of requests for each piece of content, and then perform forensic marking by combining preprocessed content files for the content or by performing forensic marking on an uncompressed original content file in real time, in accordance with the determined forensic processing method, thereby reducing the load of a content server and increasing the efficiency of storage.

In accordance with a first aspect of the present invention, there is provided a forensic marking apparatus, including: a preprocessing unit configured to selectively perform preprocessing for forensic processing on content to be provided to a user terminal; a forensic processing unit configured to perform forensic marking on the content by combining content files preprocessed by the preprocessing unit or perform the forensic marking on an uncompressed original content file in real time, in accordance with a forensic processing method set for the content; and a control unit configured to determine the forensic processing method for the content, to control the forensic processing unit so that forensic processing is performed on the content in accordance with the determined method, and to provide the forensic-processed content to the user terminal.

Further, the control unit may check the frequency of requests for the content, and determine the forensic processing method for the content based on a preset reference frequency.

Further, the control unit may perform forensic marking on the content for which the frequency of requests is equal to or lower than the reference frequency in real time.

Further, the control unit may perform forensic marking on the content for which the frequency of requests is higher than the reference frequency by combining the preprocessed content files and then performing forensic marking.

Further, the control unit may perform the preprocessing and then store the preprocessed content files, for the content for which the frequency of requests is higher than the reference frequency.

Further, the control unit may delete the stored preprocessed content files when the frequency of requests for the content has changed and decreased to a level equal to or lower than the reference frequency.

Further, the forensic processing unit may perform the forensic marking on the requested content by combining the preprocessed content files and inserting the forensic mark in conformity with information about a user who has requested the content, the information about a user being included within a content file, in accordance with the forensic processing method.

Further, the preprocessing unit may generate two preprocessed content files by performing the preprocessing on the preprocessing target content.

Further, the forensic processing unit may perform the forensic marking by inserting the forensic mark into an uncompressed content file of the requested content in real time in conformity with information about a user who has requested the content in accordance with the forensic processing method.

Further, the forensic processing unit may perform the forensic marking by repeatedly inserting a synchronization code and the forensic mark for the forensic marking into a data format of the uncompressed content file except for a header.

Further, the forensic processing unit, after the forensic marking, may generate a content file by encoding and compressing the content on which the forensic marking has been performed.

Further, the forensic processing unit may perform the forensic marking by inserting the forensic mark into an uncompressed content file of the requested content for each file/buffer unit.

In accordance with a second aspect of the present invention, there is provided a forensic marking method, including: selectively performing preprocessing for forensic processing on content to be provided to a user terminal; in response to a request for the content from the user terminal, determining a forensic processing method in compliance with a policy set for the content; performing forensic marking on the content by combining preprocessed content files of the requested content and then performing a first forensic marking or by performing a second forensic marking on an uncompressed original content file in real time, in accordance with the determined forensic processing method; and providing the forensic-processed content to the user terminal.

Further, said determining a forensic processing method may include checking the frequency of requests for the content; and the forensic processing method for the content by comparing the checked frequency of requests with a preset reference frequency.

Further, said determining a forensic processing method may include determining the forensic processing method to be a method of performing forensic marking in real time for the content for which the frequency of requests is equal to or lower than the reference frequency.

Further, said determining a forensic processing method may include determining the forensic processing method to be a method of combining the preprocessed content files and then performing forensic marking for the content for which the frequency of requests is higher than the reference frequency.

Further, said determining a first forensic marking may include performing the forensic marking on the requested content by combining the preprocessed content files and then inserting the forensic mark in conformity with information about a user who has requested the content, the information about a user being included within a content file

Further, said determining a second forensic marking may include performing the forensic marking by inserting the forensic mark into an uncompressed content file of the requested content in real time in conformity with information about a user who has requested the content.

Further, said determining a second forensic marking may include performing the forensic marking by repeatedly inserting a synchronization code and the forensic mark for the forensic marking into a data format of the uncompressed content file except for a header.

Further, said determining a second forensic marking may include: after the forensic marking, encoding the content on which the forensic marking has been performed; and compressing the encoded content, thereby generating a content file.

The present invention has the advantages of reducing the load of the server and increasing the efficiency of storage because it utilizes the method of using an uncompressed file and the method of using compressed audio files in a preprocessing process in order to provide a download and streaming service in the forensic marking server for a real-time service.

Furthermore, when the real-time combination method is used for content, such as an MP3 compressed audio file, the present invention has the advantage of constructing a real-time audio forensic marking system independent of a specific forensic marking algorithm, and the advantage of reducing the time it takes to perform the forensic marking of user information and thus shortening the waiting time that is required when the download or streaming of a file starts.

### BRIEF DESCRIPTION OF THE DRAWINGS

The above and other objects and features of the present invention will become apparent from the following description of preferred embodiments given in conjunction with the accompanying drawings, in which:

FIG. 1 illustrates a network configuration for real-time content service, including a forensic marking apparatus in accordance with an embodiment of the present invention;

FIG. 2 is a detailed block diagram of a forensic marking apparatus in accordance with an embodiment of the present invention;

FIG. 3 is a flowchart illustrating the control flow of a forensic marking operation for a real-time service in accordance with an embodiment of the present invention;

FIG. 4 is a diagram illustrating the concept of performing forensic marking using a preprocessing forensic marking method in accordance with an embodiment of the present invention; and

FIG. 5 is a diagram illustrating the concept of performing forensic marking using a real-time forensic marking processing method in accordance with an embodiment of the present invention.

### DETAILED DESCRIPTION OF THE PREFERRED EMBODIMENTS

Hereinafter, preferred embodiments of the present invention will be described in detail with reference to the accompanying drawings so that they can be readily implemented by those skilled in the art.

In the following description, detailed descriptions of known functions and constructions which have been deemed to make the gist of the present invention unnecessarily vague will be omitted. The terms used in the following description are defined based on the functions thereof in conjunction with the present invention, and the meanings thereof may vary depending on a user or administrator's intention or customs. Therefore, the definitions of the terms should be made based on the technical spirit that is described throughout the specification and claims.

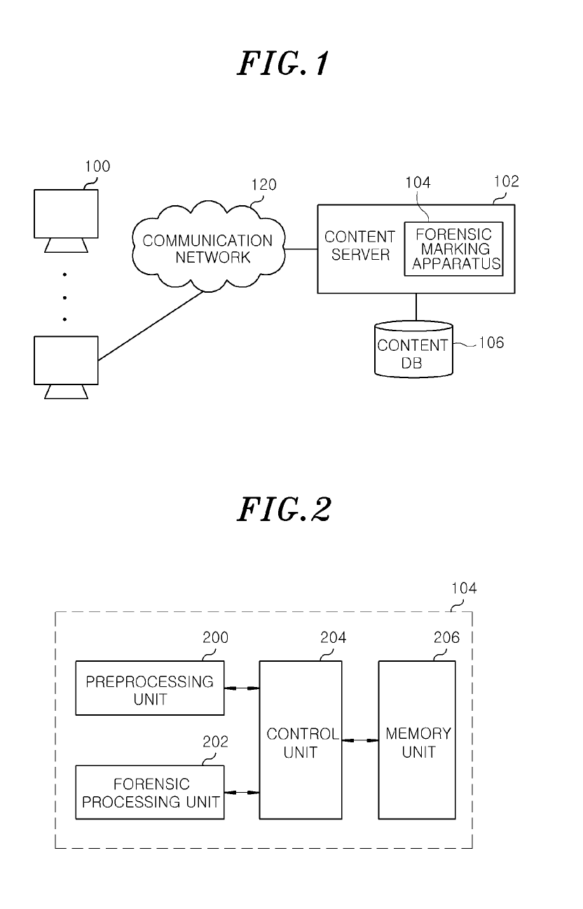

FIG. 1 illustrates a network configuration for real-time content service, including a forensic marking apparatus in accordance with an embodiment of the present invention.

Referring to FIG. 1, each of a plurality of user terminals 100 is a terminal device having a computing function, which may connect to a content server 102 over a communication network 120, download multimedia content, such as digital audio or video, and play back the downloaded content. The user terminal 100 may be, for example, a smart phone, a tablet personal computer (PC), or a PC. That is, the user terminal 100 may connect to the content server 102 over the communication network 120, such as the Internet, search various types of multimedia content provided by the content server 102, select desired content, and request a download or streaming service for the selected content.

The content server 102 may store a variety of types of content, such as digital audio and video, to provide a download service or a streaming service to the plurality of user terminals 100 over the communication network 120, perform forensic processing on content requested by the user terminal 100 using a forensic marking apparatus 104, and provide the content to the user terminal 100.

A content database (DB) 106 is a database content server 102 that stores original content to be provided to the user terminal 100. Here, the content may be multimedia data, such as digital audio and video.

The forensic marking apparatus 104 may be installed in the content server 102 in order to manage content and track a leakage path, and performs forensic marking on content to be provided to the user terminal 100.

FIG. 2 illustrates a detailed block configuration of the forensic marking apparatus 104 in accordance with an embodiment of the present invention. The forensic marking apparatus 104 may include a preprocessing unit 200, a forensic processing unit 202, a control unit 204, and a memory unit 206.

The detailed operations of the respective components of the forensic marking apparatus 104 in accordance with the embodiment of the present invention will be described below with reference to FIG. 2.

First, the preprocessing unit 200 selectively performs preprocessing for forensic processing on content to be provided to the user terminal 100.

That is, the preprocessing unit 200 previously generates two preprocessing content files for the content for which a forensic processing method has been determined to be a forensic processing method of performing combination after preprocessing in compliance with a policy based on, for example, the frequency of requests for each piece of content. Here, for example, in the case of an original compressed audio file, such as an MP3 file, two compressed audio files into which “0s” and “1s” have been inserted, respectively, may be generated through decoding and forensic marking preprocessing. These preprocessed content files may be stored in the memory unit 206.

The forensic processing unit 202 may perform forensic marking by combining content files that are obtained by preprocessing content, requested by the user terminal 100, by means of the preprocessing unit 200 in accordance with a forensic processing method set for each piece of content, or may perform forensic marking on an uncompressed original content file in real time.

That is, the forensic processing unit 202 may perform forensic marking by combining content files obtained by preprocessing content in accordance with a corresponding forensic processing method and inserting a forensic mark in conformity with information about a user who has requested the content. Here, the information about a user who has requested the content is included within a content file.

Furthermore, the forensic processing unit 202 may perform forensic marking by inserting a forensic mark into an uncompressed content file in conformity with information about a user who has requested the content in real time in accordance with a forensic processing method. Here, the forensic processing unit 202 may perform forensic marking by repeatedly inserting a synchronization code and a forensic mark for the forensic marking into the data format of the uncompressed content file except for the header.

When the user terminal 100 requests a download or streaming service for content, the control unit 204 determines a forensic processing method for the requested content, performs control so that forensic processing is performed via the forensic processing unit 202 in accordance with the determined method, and provides the forensic-processed content to the corresponding user terminal 100. When determining the forensic processing method for content, the control unit 204 may check the frequency of requests for the content and determine the forensic processing method for the content based on a preset reference frequency. That is, the control unit 204 may check the frequency of requests for content, and may perform forensic marking on the content for which the frequency of requests is equal to or lower than the reference frequency in a real-time processing manner, or perform forensic marking on the content for which the frequency of requests is higher than the reference frequency in a preprocessing manner that uses the combination of preprocessed content files.

Furthermore, the control unit 204 stores preprocessed content files in the memory unit 206 for content on which forensic marking will be performed by combining the preprocessed content files. As the amount of content increases, the efficiency of the memory unit 206 may be reduced. Accordingly, the control unit 204 may be configured to operate in such a way as to periodically check the frequency of requests for each piece of content and, if the frequency of requests for the content has changed and decreased to a level equal to or lower than the reference frequency, delete previously stored preprocessed content files for the content, thereby increasing the efficiency of the memory unit 206.

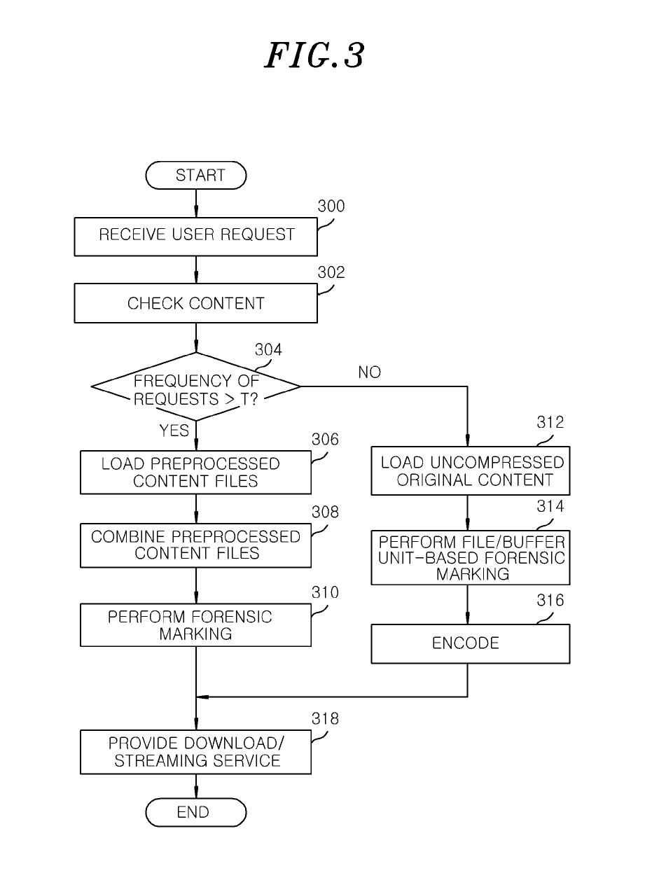

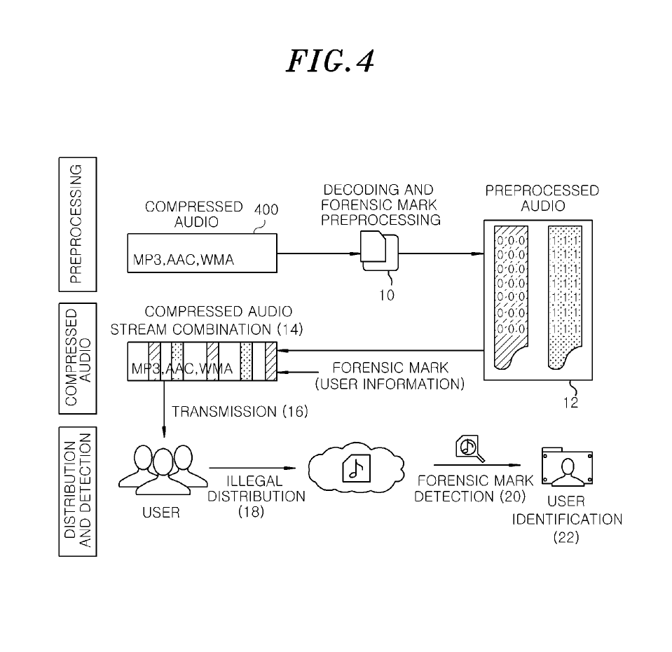

FIG. 3 illustrates the control flow of an operation of performing forensic marking on content using the forensic marking apparatus 104 in accordance with an embodiment of the present invention. The process in accordance with the embodiment of the present invention will be described in detail with reference to FIGS. 1, 2, and 3.

First, when there is a request for content from the user terminal 100 in operation 300, the control unit 204 of the forensic marking apparatus 104 checks the content requested by the user terminal 100 in operation 302.

Thereafter, the control unit 204 checks the frequency of requests for the content requested for a download or streaming service by the user terminal 100, and then compares the frequency of requests for the content with a reference frequency T set as a reference for a forensic processing method in operation 304.

In this case, if the frequency of requests for the content requested by the user terminal is higher than the reference frequency T, the control unit 204 determines a forensic processing method for the corresponding content to be a preprocessing method. The determined forensic processing method is provided to the forensic processing unit 202 that performs forensic marking on the content.

Then the forensic processing unit 202 reads preprocessed content files related to the corresponding content from the memory unit 206 in operation 306. The preprocessed content files have been previously generated by the preprocessing unit 200 and then stored in the memory unit 206. For example, in the case of an original compressed audio file, such as an MP3 file, two compressed audio files into which “0s” and “1s” have been inserted, respectively, may be generated through decoding and forensic marking preprocessing.

Then the forensic processing unit 202 combines the two content files preprocessed for the content by the preprocessing unit 200 in operation 308, and performs forensic marking by inserting a forensic mark in conformity with information about a user who has requested the content, the information about the user being included within a content file, in operation 310.

Accordingly, a content file in which user information has been forensically marked in original content is generated. The control unit 204 provides the generated forensically marked content file to the corresponding user terminal 100 in the form of a download or streaming service in operation 318.

Meanwhile, in contrast, if the frequency of requests for content that is requested by the user terminal 100 is equal to or lower than the reference frequency, the control unit 204 determines a forensic processing method for the corresponding content to be a real-time processing method.

The forensic processing method determined as described above is provided to the forensic processing unit 202 that performs forensic marking on the content.

Then the forensic processing unit 202 reads the uncompressed original content of the corresponding content in operation 312, and performs forensic marking by inserting a forensic mark into an uncompressed content file in real time in conformity with information about a user who has requested the content in operation 314. Here, the forensic processing unit 202 may be configured to repeatedly insert a synchronization code and a forensic mark for forensic marking into the data format of the uncompressed content file, except for the header, when performing forensic marking.

Thereafter, the forensic processing unit 202 encodes and compresses the content on which the forensic marking has been performed, thereby generating a content file in operation 316.

The control unit 204 then provides the generated forensically marked content file to the corresponding user terminal 100 in the form of a download or streaming service in operation 318.

As described above, the content server 102 of the present invention applies a forensic marking method that varies depending on the frequency of user requests. First, if the frequency of requests is equal to or lower than a predetermined level, or a user makes a request in the initial stage of service, the server performs forensic marking on an uncompressed audio file, encodes the uncompressed audio file, and provides a service. This method can efficiently manage the storage space of the server 102, and applies the process of performing and then encoding forensic marking on the small buffer units of an audio file not only to a download service but also to a streaming service, thereby achieving real-time performance and superior storage efficiency. However, this method may cause burden to the server 102 when being applied to a number of files at the same time because a large amount of computational load is required.

Accordingly, for a file for which the frequency of user requests is higher than the predetermined level, such as a specific hit song file, compressed files forensically marked with 0s and 1s, respectively, are previously prepared before a user request is made. These compressed audio files preprocessed as described above enable a forensically marked audio file to be generated at a very high speed in response to a user request by combining the two preprocessing files in conformity with user information. However, this method may reduce storage efficiency because the server 102 should store the files that have been forensically marked with 0s and 1s.

That is, using a mixture of the advantages of the two forensic marking methods, the present invention applies a forensic marking combination method using a preprocessing process only to a file for which the frequency of user requests is high and applies a method of performing successive forensic marking on small segments corresponding to buffer units to a file for which the frequency of requests is low, thereby maximizing real-time performance and the efficiency of storage. Furthermore, in the case of a hit song, if the frequency of requests for the song has changed to a level equal to or lower than a predetermined frequency over time, the waste of a storage resource can be reduced by deleting two stored preprocessed files.

FIG. 4 illustrates the concept of performing forensic marking in a preprocessing manner in accordance with an embodiment of the present invention. Although digital audio content, such as an MP3 file, will be illustrated as an example in the following description for convenience of description, the following description may be applied to all other types of content in the same manner.

Referring to FIG. 4, first, at a preprocessing step S12, two compressed audio files into which 0s and 1s have been inserted are generated by performing decoding and forensic mark preprocessing S10 on an original compressed audio file 400, such as an MP3 file. Furthermore, at a compressed audio stream combination step, when an actual request is made by a user, preprocessed compressed audio streams are combined again in order of bits that constitute user identification information in operation 14.

The forensically marked MP3 file generated as described above may be sent to a user without delay in operation 16. When illegal distribution occurs in operation 18, the forensic mark may be extracted from the corresponding file in operation 20, be used to identify the user in operation 22.

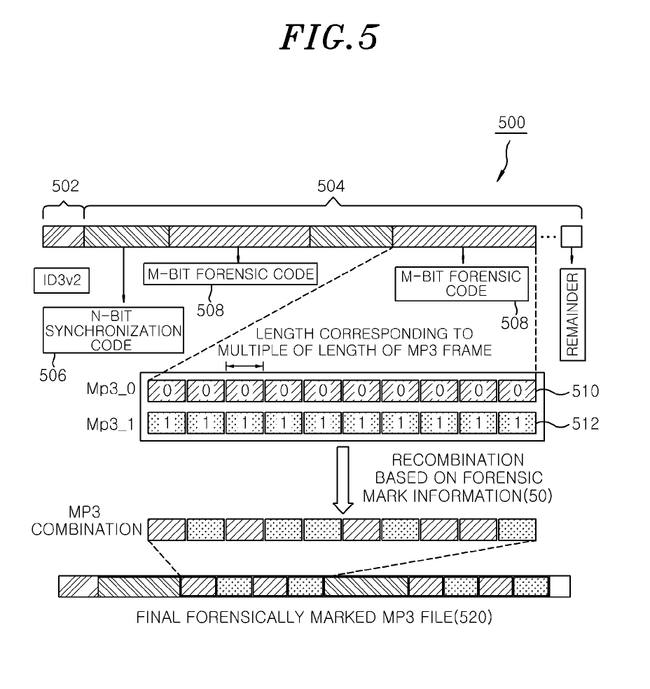

FIG. 5 is a diagram illustrating the concept of performing forensic marking using a real-time forensic marking processing method in accordance with an embodiment of the present invention. Although digital audio content, such as a MP3 file, will be illustrated as an example in the following description for convenience of description, the following description may be applied to all other types of content in the same manner.

Referring to FIG. 5, a MP3 file 500 has a structure in which a LAME header 502 called ID3v2 is followed by an MP3 frame 504. A synchronization code 506 and a forensic code 508, that is, identification information, for forensic marking are repeatedly inserted into the section of the MP3 file 500, other than the ID3v2 header 502.

In this case, in order to achieve real-time performance, two MP3 files 510 and 512 in which 0s and 1s have been previously inserted into portions into which the forensic code 508 will be inserted. The length of each portion into which one bit, such as 0 or 1, will be inserted is configured to correspond to a multiple of the length of an MP3 frame. When a user request is made after the above-described preprocessing has been performed, a final forensically marked MP3 file may be generated by combining an “MP3_{—}0” file 510 into which 0s have been inserted and an “MP3_{—}1” file 512 into which is have been inserted on a bit basis in conformity with the user information. In FIG. 5, the processing speed may be further improved by previously generating an ID3v2 502, synchronization codes 506, and the remaining portion other than the forensic codes 508, which are the format of the MP3 file 500 except for the forensic codes 508.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A forensic marking apparatus, comprising:
a preprocessing unit configured to selectively perform preprocessing for forensic processing on content to be provided to a user terminal;
a forensic processing unit configured to perform forensic marking on the content by combining content files preprocessed by the preprocessing unit or perform the forensic marking on an uncompressed original content file in real time, in accordance with a forensic processing method set for the content; and
a control unit configured to determine the forensic processing method for the content, to control the forensic processing unit so that forensic processing is performed on the content in accordance with the determined method, and to provide the forensic-processed content to the user terminal.

2. The forensic marking apparatus of claim 1, wherein the control unit checks the frequency of requests for the content, and determines the forensic processing method for the content based on a preset reference frequency.

3. The forensic marking apparatus of claim 2, wherein the control unit performs forensic marking on the content for which the frequency of requests is equal to or lower than the reference frequency in real time.

4. The forensic marking apparatus of claim 2, wherein the control unit performs forensic marking on the content for which the frequency of requests is higher than the reference frequency by combining the preprocessed content files and then performing forensic marking.

5. The forensic marking apparatus of claim 4, wherein the control unit performs the preprocessing and then stores the preprocessed content files, for the content for which the frequency of requests is higher than the reference frequency.

6. The forensic marking apparatus of claim 5, wherein the control unit deletes the stored preprocessed content files when the frequency of requests for the content has changed and decreased to a level equal to or lower than the reference frequency.

7. The forensic marking apparatus of claim 1, wherein the forensic processing unit performs the forensic marking on the requested content by combining the preprocessed content files and inserting the forensic mark in conformity with information about a user who has requested the content, the information about a user being included within a content file, in accordance with the forensic processing method.

8. The forensic marking apparatus of claim 1, wherein the preprocessing unit generates two preprocessed content files by performing the preprocessing on the preprocessing target content.

9. The forensic marking apparatus of claim 1, wherein the forensic processing unit performs the forensic marking by inserting the forensic mark into an uncompressed content file of the requested content in real time in conformity with information about a user who has requested the content in accordance with the forensic processing method.

10. The forensic marking apparatus of claim 9, wherein the forensic processing unit performs the forensic marking by repeatedly inserting a synchronization code and the forensic mark for the forensic marking into a data format of the uncompressed content file except for a header.

11. The forensic marking apparatus of claim 9, wherein the forensic processing unit, after the forensic marking, generates a content file by encoding and compressing the content on which the forensic marking has been performed.

12. The forensic marking apparatus of claim 9, wherein the forensic processing unit performs the forensic marking by inserting the forensic mark into an uncompressed content file of the requested content for each file/buffer unit.

13. A forensic marking method, comprising:
selectively performing preprocessing for forensic processing on content to be provided to a user terminal;
in response to a request for the content from the user terminal, determining a forensic processing method in compliance with a policy set for the content;
performing forensic marking on the content by combining preprocessed content files of the requested content and then performing a first forensic marking or by performing a second forensic marking on an uncompressed original content file in real time, in accordance with the determined forensic processing method; and
providing the forensic-processed content to the user terminal.

14. The forensic marking method of claim 13, wherein said determining a forensic processing method includes:
checking the frequency of requests for the content; and
the forensic processing method for the content by comparing the checked frequency of requests with a preset reference frequency. 25

15. The forensic marking method of claim 14, wherein said determining a forensic processing method includes determining the forensic processing method to be a method of performing forensic marking in real time for the content for which the frequency of requests is equal to or lower than the reference frequency.

16. The forensic marking method of claim 14, wherein said determining a forensic processing method includes determining the forensic processing method to be a method of combining the preprocessed content files and then performing forensic marking for the content for which the frequency of requests is higher than the reference frequency.

17. The forensic marking method of claim 13, wherein said determining a first forensic marking includes performing the forensic marking on the requested content by combining the preprocessed content files and then inserting the forensic mark in conformity with information about a user who has requested the content, the information about a user being included within a content file

18. The forensic marking method of claim 13, wherein said determining a second forensic marking includes performing the forensic marking by inserting the forensic mark into an uncompressed content file of the requested content in real time in conformity with information about a user who has requested the content.

19. The forensic marking method of claim 18, wherein said determining a second forensic marking includes performing the forensic marking by repeatedly inserting a synchronization code and the forensic mark for the forensic marking into a data format of the uncompressed content file except for a header.

20. The forensic marking method of claim 18, wherein said determining a second forensic marking includes:
after the forensic marking, encoding the content on which the forensic marking has been performed; and
compressing the encoded content, thereby generating a content file.
